(19) United States
(12) Patent Application Publication
(10) Pub. No.: US 2017/0160864 A1
(43) Pub. Date: Jun. 8, 2017

(54) DISPLAY METHOD AND TERMINAL INCLUDING TOUCH SCREEN PERFORMING THE SAME

(71) Applicant: HiDeep Inc., Gyeonggi-do (KR)

(72) Inventors: Byung Sun Lee, Gyeonggi-do (KR); Moon Hyeok Choi, Gyeonggi-do (KR); Ho Jun Moon, Gyeonggi-do (KR)

(21) Appl. No.: 15/367,620

(22) Filed: Dec. 2, 2016

(30) Foreign Application Priority Data
Dec. 4, 2015 (KR) 1020150172704

(51) Int. Cl. G06F 3/041; G06F 3/044

(52) U.S. Cl. CPC G06F 3/0416; G06F 3/044; G06F 3/0412; G06F 2203/04101; G06F 2203/04104; G06F 2203/04107; G06F 2203/04105; G02F 1/13338

(57) ABSTRACT

A terminal may be provided that includes: a touch screen; a processor; and a controller. When a touch is input to the touch screen, the processor detects a position of the touch and a magnitude of a pressure of the touch and transfers information on the touch position and information on the magnitude of the touch pressure to the controller. Based on the magnitude of the touch pressure, the controller changes an image which is displayed on a change target region around the touch position, and displays the changed image on the touch screen. The change target region includes a first region and a second region disposed within the first region, an image enlarged perpendicularly to the boundary of the first region is displayed on the first region, and an image reduced perpendicularly to the boundary of the second region is displayed on the second region.

### CROSS REFERENCE TO RELATED APPLICATIONS

Priority is claimed under 35 U.S.C. §119 to Korean Patent Application No. 10-2015-0172704, filed Dec. 4, 2015, the disclosure of which is incorporated by reference in its entirety.

### BACKGROUND

Field

The present disclosure relates to a display method and a terminal including a touch screen performing the same.

Description of the Related Art

A touch screen is used in a portable electronic device such as a personal digital assistant (PDA), a tabletop, and a mobile device. A touch by a pointing device (or stylus) or a finger is input through the touch screen.

However, it is very difficult or impossible to customize the touch screen for convenience of users because a terminal including such a touch screen has generally a fixed shape and size. Moreover, there is a tendency to widen and enlarge the touch screen of the terminal equipped with the touch screen, so that a user has a difficulty in operating the terminal throughout the entire touch screen by one hand. Also, icons are distributed on a plurality of pages in the terminal including the touch screen. As a result, many operations are required to perform an action assigned to the icon to be used.

Therefore, there is a requirement for improvement of user's convenience by providing an intuitive interfacing technology of providing natural interface and of enhancing the interaction between human being and computers.

### BRIEF SUMMARY

One embodiment is a terminal that includes: a touch screen; a processor; and a controller. When a touch is input to the touch screen, the processor detects a position of the touch and a magnitude of a pressure of the touch and transfers information on the touch position and information on the magnitude of the touch pressure to the controller. Based on the magnitude of the touch pressure, the controller changes an image which is displayed on a change target region around the touch position, and displays the changed image on the touch screen. The change target region includes a first region and a second region disposed within the first region, an image enlarged perpendicularly to the boundary of the first region is displayed on the first region, and an image reduced perpendicularly to the boundary of the second region is displayed on the second region.

### BRIEF DESCRIPTION OF THE DRAWINGS

FIG. 1 is a structure view of a terminal according to an embodiment of the present invention;

FIGS. 2a and 2b are views for describing the capacitance change amount due to a pressure;

FIGS. 3a and 3b are views for describing a touch region by an object;

FIGS. 4a and 4b are views for describing the touch time period;

FIG. 5 is a flowchart for describing an image change according to the embodiment of the present invention;

FIG. 6 shows image change information according to the embodiment of the present invention;

FIGS. 7a to 11c show a method for changing the image in accordance with the magnitude of a pressure and for displaying the changed image on a touch screen in accordance with a first embodiment of the present invention;

FIGS. 12a to 14b show a method for changing the image in accordance with the magnitude of a pressure and for displaying the changed image on a touch screen in accordance with a second embodiment of the present invention;

FIGS. 15a to 15b are views for describing a method for setting a change target region or a second region in accordance with the touch region;

FIGS. 16a to 17b are views for describing a method for informing a user that the magnitude of a pressure of an input touch approaches or reaches a maximum pressure level;

FIG. 18 is a view showing the structure of the touch screen according to the first embodiment;

FIGS. 19a to 19d are views showing the structure of a touch position detection module of the touch screen according to the first embodiment;

FIGS. 20a to 20f are views showing the structure of a touch pressure detection module of the touch screen according to the first embodiment;

FIG. 21 is a view showing the structure of the touch screen according to the second embodiment;

FIGS. 22a to 22k are views showing the structure of a touch position-pressure detection module of the touch screen according to the second embodiment;

FIG. 23 is a view showing the structure of a touch screen according to a third embodiment;

FIGS. 24a to 24b are views showing the structure of a touch pressure detection module of the touch screen according to the third embodiment;

FIG. 25a is a view showing the structure of a touch screen according to a fourth embodiment;

FIGS. 25b and 25c are structure views for describing a touch pressure detection and a touch position detection of the touch screen according to the fourth embodiment respectively; and

FIGS. 26a to 26d are structure views showing the shape of an electrode formed on the touch detection module according to the embodiment.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, a display method and a terminal 100 including a touch screen performing the same will be described.

FIG. 1 is a structure view of the terminal 100 according to an embodiment of the present invention.

The terminal 100 according to the embodiment may include a controller 110, a touch screen 130, and a processor 140.

The terminal 100 includes the touch screen 130. Input to the terminal 100 may be performed by touching the touch screen 130.

The terminal 100 may be a portable electronic device such as a laptop computer, a personal digital assistant (PDA) and a smartphone. Also, the terminal 100 may be a non-portable electronic device such as a desktop computer and a smart television.

FIG. 18 is a view showing the structure of the touch screen according to a first embodiment.

As shown in FIG. 18, the touch screen 130 may include a touch position detection module 1000, a touch pressure detection module 2000 disposed under the touch position detection module 1000, a display module 3000 disposed under the touch pressure detection module 2000, and a substrate 4000 disposed under the display module 3000. For example, the touch position detection module 1000 and the touch pressure detection module 2000 may be a transparent panel including a touch-sensitive surface. Hereafter, the modules 1000, 2000, 3000 and 5000 for detecting the touch position and/or touch pressure may be collectively designated as a touch detection module.

The display module 3000 is able to display the screen to allow a user to visually check contents. Here, the display module 3000 may display by means of a display driver. The display driver (not shown) is software allowing an operating system to manage or control a display adaptor and is a kind of a device driver.

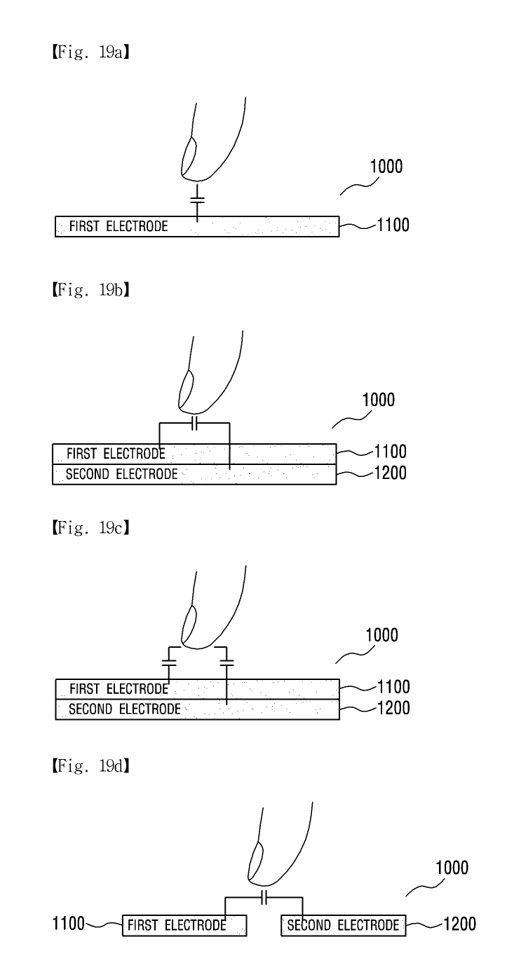

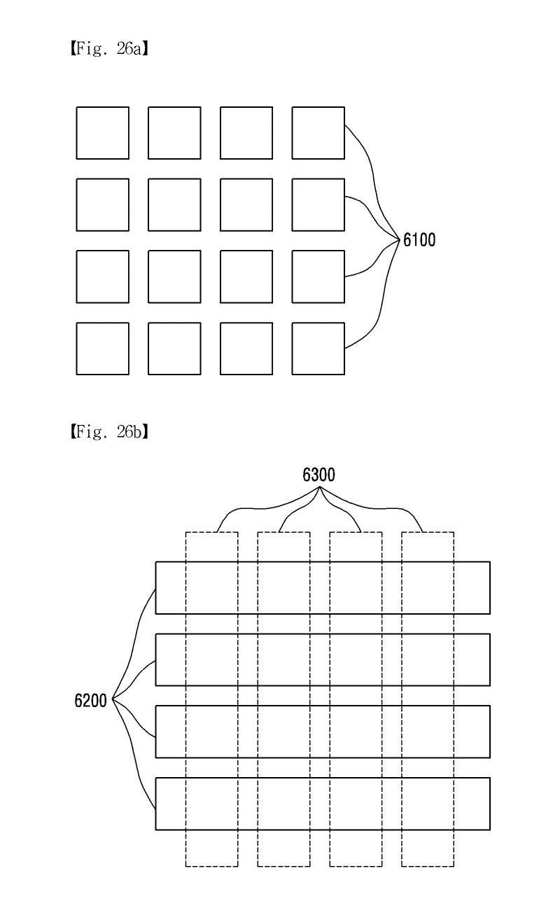

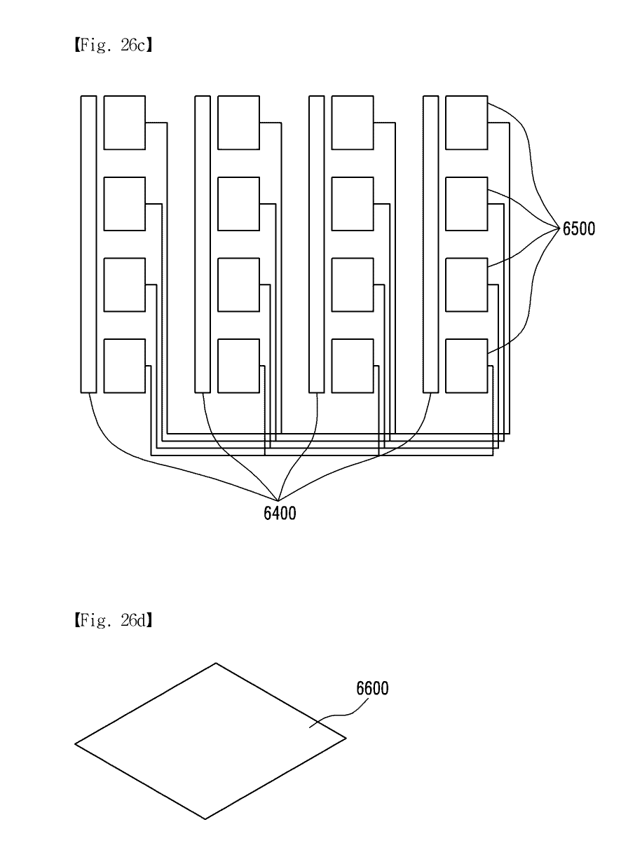

FIGS. 19a to 19d are views showing the structure of the touch position detection module according to the first embodiment. FIGS. 26a to 26d are structure views showing the shape of an electrode formed on the touch position detection module according to the embodiment.

As shown in FIG. 19a, the touch position detection module 1000 according to the embodiment may include a first electrode 1100 formed in one layer. Here, the first electrode 1100 may be, as shown in FIG. 26a, comprised of a plurality of electrodes 6100, and then a driving signal may be input to each electrode 6100 and a detection signal including information on self-capacitance may be output from each electrode. When an object like a user's finger approaches the first electrode 1100, the finger functions as a ground and the self-capacitance of first electrode 1100 is changed. Therefore, the terminal 100 is able to detect the touch position by measuring the self-capacitance of the first electrode 1100, which is changed as the object like the user's finger approaches the touch screen 130.

As shown in FIG. 19b, the touch position detection module 1000 according to the embodiment may include the first electrode 1100 and a second electrode 1200, which are formed on different layers.

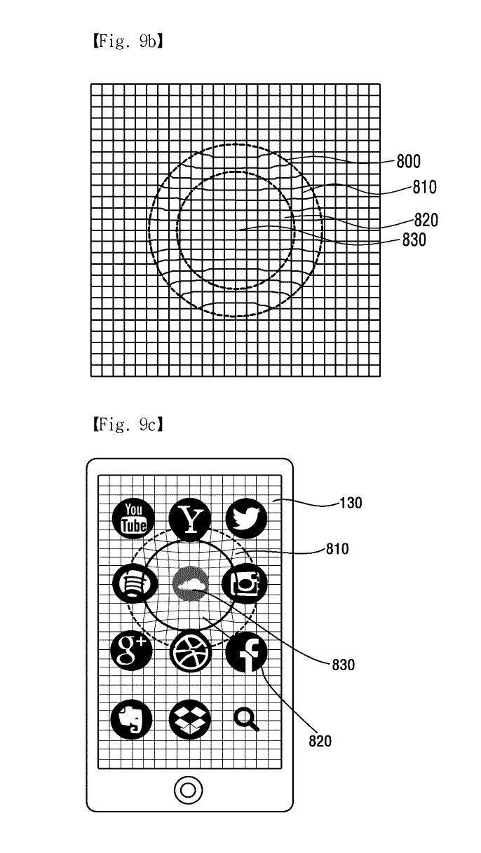

Here, the first and the second electrodes 1100 and 1200 are, as shown in FIG. 26b, comprised of a plurality of first electrodes 6200 and a plurality of second electrodes 6300 respectively. The plurality of first electrodes 6200 and the plurality of second electrodes 6300 may be arranged to cross each other. A driving signal may be input to any one of the first electrode 6200 and the second electrode 6300, and a detection signal including information on mutual capacitance may be output from the other. As shown in FIG. 9b, when the object like the user's finger approaches the first electrode 1100 and the second electrode 1200, the finger functions as a ground, so that the mutual capacitance between the first electrode 1100 and the second electrode 1200 is changed. In this case, the terminal 100 measures the mutual capacitance between the first electrode 1100 and the second electrode 1200, which is changed with the approach of the object like the user's finger to the touch screen 130, and then detects the touch position. Also, the driving signal may be input to the first electrode 6200 and the second electrode 6300, and a detection signal including information on the self-capacitance may be output from the first and second electrodes 6200 and 6300 respectively. As shown in FIG. 9c, when the object like the user's finger approaches the first electrode 1100 and the second electrode 1200, the finger functions as a ground, so that the self-capacitance of each of the first and second electrodes 1100 and 1200 is changed. In this case, the terminal 100 measures the self-capacitances of the first electrode 1100 and the second electrode 1200, which is changed with the approach of the object like the user's finger to the touch screen 130, and then detects the touch position.

As shown in FIG. 19d, the touch position detection module 1000 according to the embodiment may include the first electrode 1100 formed in one layer and the second electrode 1200 formed in the same layer as the layer in which the first electrode 1100 has been formed.

Here, the first and the second electrodes 1100 and 1200 are, as shown in FIG. 26c, comprised of a plurality of first electrodes 6400 and a plurality of second electrodes 6500 respectively. The plurality of first electrodes 6400 and the plurality of second electrodes 6500 may be arranged without crossing each other and may be arranged such that the plurality of second electrodes 6500 are connected to each other in a direction crossing the extension direction of the each first electrodes 6400. A principle of detecting the touch position by using the first electrode 6400 or the second electrode 6500 shown in FIG. 19d is the same as that of the foregoing referring to FIG. 19c, and thus a description of the principle will be omitted.

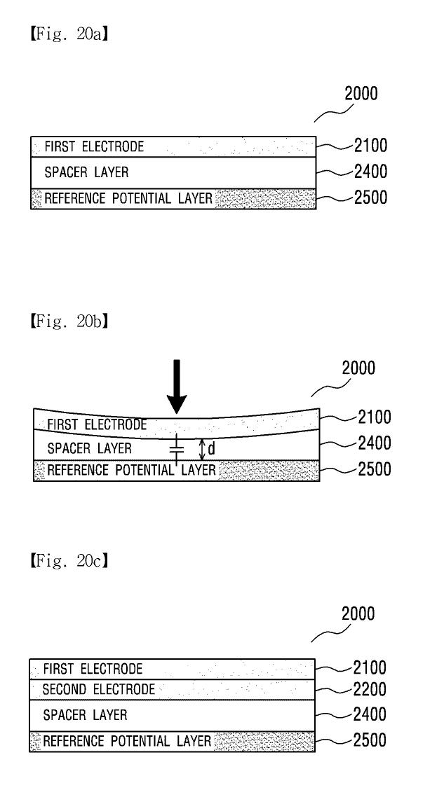

FIGS. 20a to 20f are views showing the structure of the touch pressure detection module according to the first embodiment. FIGS. 26a to 26d are structure views showing the shape of an electrode formed on the touch pressure detection module according to the embodiment.

As shown in FIGS. 20 to 20f, the touch pressure detection module 2000 according to the first embodiment may include a spacer layer 2400. The spacer layer 2400 may be implemented by an air gap. The spacer may be comprised of an impact absorbing material according to the embodiment and may be also filled with a dielectric material according to the embodiment.

As shown in FIGS. 20a to 20d, the touch pressure detection module 2000 according to the first embodiment may include a reference potential layer 2500. The reference potential layer 2500 may have any potential. For example, the reference potential layer may be a ground layer having a ground potential. Here, the reference potential layer may include a layer which is parallel with a two-dimensional plane in which a below-described first electrode 2100 for detecting the touch pressure has been formed or a two-dimensional plane in which a below-described second electrode 2200 for detecting the touch pressure has been formed. Although it has been described in FIGS. 20a to 20d that the touch pressure detection module 2000 includes the reference potential layer 2500, there is no limit to this. The touch pressure detection module 2000 does not include the reference potential layer 2500, and the display module 3000 or the substrate 4000 which is disposed under the touch pressure detection module 2000 may function as the reference potential layer.

As shown in FIG. 20a, the touch pressure detection module 2000 according to the embodiment may include the first electrode 2100 formed in one layer, the spacer layer 2400 formed under the layer in which the first electrode 2100 has been formed, and the reference potential layer 2500 formed under the spacer layer 2400.

Here, the first electrode 2100 is, as shown in FIG. 26a, comprised of the plurality of electrodes 6100. Then, the driving signal may be input to each of the electrodes 6100 and the detection signal including information on the self-capacitance may be output from each electrode. When a pressure is applied to the touch screen 130 by the object like the user's finger or stylus, the first electrode 2100 is, as shown in FIG. 20b, curved at least at the touch position, so that a distance “d” between the first electrode 2100 and the reference potential layer 2500 is changed, and thus, the self-capacitance of the first electrode 2100 is changed. Accordingly, the terminal 100 is able to detect the touch pressure by measuring the self-capacitance of the first electrode 2100, which is changed by the pressure that the object like the user's finger or stylus applies to the touch screen 130. As such, since the first electrode 2100 is comprised of the plurality of electrodes 6100, the terminal 100 is able to detect the pressure of each of multiple touches which have been simultaneously input to the touch screen 130. Also, when there is no requirement for detecting the pressure of each of multiple touches, it is only required to detect overall pressure applied to the touch screen 130 irrespective of the touch position. Therefore, the first electrode 2100 of the touch pressure detection module 2000 may be, as shown in FIG. 12d, comprised of one electrode 6600.

As shown in FIG. 20c, the touch pressure detection module 2000 according to the embodiment may include the first electrode 2100, the second electrode 2200 formed under the layer in which the first electrode 2100 has been formed, the spacer layer 2400 formed under the layer in which the second electrode 2200 has been formed, and the reference potential layer 2500 formed under the spacer layer 2400.

Here, the first electrode 2100 and the second electrode 2200 may be configured and arranged as shown in FIG. 26b. A driving signal is input to any one of the first electrode 6200 and the second electrode 6300, and a detection signal including information on the mutual capacitance may be output from the other. When a pressure is applied to the touch screen 130, the first electrode 2100 and the second electrode 2200 are, as shown in FIG. 20d, curved at least at the touch position, so that a distance “d” between the reference potential layer 2500 and both the first electrode 2100 and the second electrode 2200 is changed, and thus, the mutual capacitance between the first electrode 2100 and the second electrode 2200 is changed. Accordingly, the terminal 100 is able to detect the touch pressure by measuring the mutual capacitance between the first electrode 2100 and the second electrode 2200, which is changed by the pressure that is applied to the touch screen 130. As such, since the first electrode 2100 and the second electrode 2200 are comprised of the plurality of first electrodes 6200 and the plurality of second electrodes 6300 respectively, the terminal 100 is able to detect the pressure of each of multiple touches which have been simultaneously input to the touch screen 130. Also, when there is no requirement for detecting the pressure of each of multiple touches, at least one of the first electrode 2100 and the second electrode 2200 of the touch pressure detection module 2000 may be, as shown in FIG. 26d, comprised of the one electrode 6600.

Here, even when the first electrode 2100 and the second electrode 2200 are formed in the same layer, the touch pressure can be also detected as described in FIG. 20c. The first electrode 2100 and the second electrode 2200 may be configured and arranged as shown in FIG. 26c, or may be comprised of the one electrode 6600 as shown in FIG. 26d.

As shown in FIG. 20e, the touch pressure detection module 2000 according to the embodiment may include the first electrode 2100 formed in one layer, the spacer layer 2400 formed under the layer in which the first electrode 2100 has been formed, and the second electrode 2200 formed under the spacer layer 2400.

In FIG. 20e, the configuration and operation of the first electrode 2100 and the second electrode 2200 are the same as those of the foregoing referring to FIG. 20c, and thus, a description of the configuration and operation will be omitted. When a pressure is applied to the touch screen 130, the first electrode 2100 is, as shown in FIG. 20f, curved at least at the touch position, so that a distance “d” between the first electrode 2100 and the second electrode 2200 is changed, and thus, the mutual capacitance between the first electrode 2100 and the second electrode 2200 is changed. Accordingly, the terminal 100 is able to detect the touch pressure by measuring the mutual capacitance between the first electrode 2100 and the second electrode 2200.

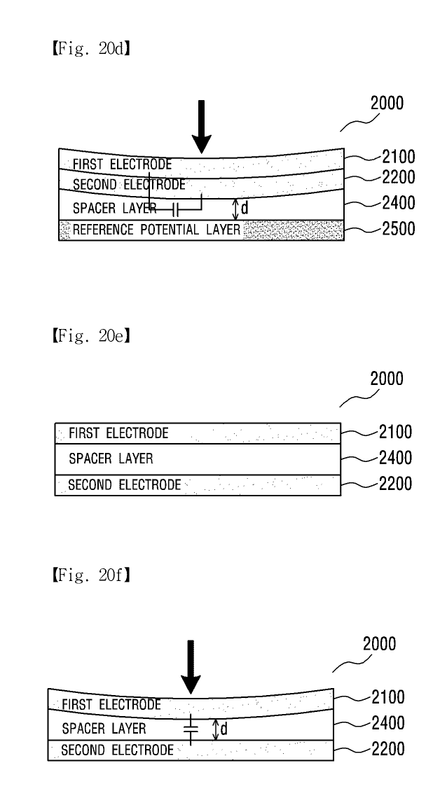

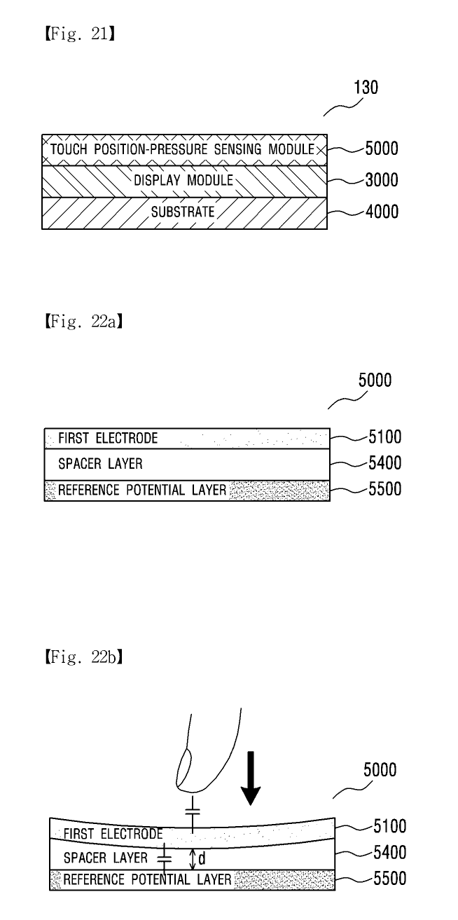

As shown in FIG. 21, the touch screen 130 according to a second embodiment may include the touch position-pressure detection module 5000, the display module 3000 disposed under the touch position-pressure detection module 5000, and the substrate 4000 disposed under the display module 3000.

Unlike the embodiment shown in FIG. 18, the touch position-pressure detection module 5000 according to the embodiment shown in FIG. 21 includes at least one electrode for detecting the touch position, and at least one electrode for detecting the touch pressure. At least one of the electrodes is used to detect both the touch position and the touch pressure. As such, the electrode for detecting the touch position and the electrode for detecting the touch pressure are shared, so that it is possible to reduce the manufacturing cost of the touch position-pressure detection module, to reduce the overall thickness of the touch screen 130 and to simplify the manufacturing process. In the sharing of the electrode for detecting the touch position and the electrode for detecting the touch pressure, when it is necessary to distinguish between the detecting signal including information on the touch position and the detecting signal including information on the touch pressure, it is possible to distinguish and detect the touch position and the touch pressure by differentiating a frequency of the driving signal for detecting the touch position from a frequency of the driving signal for detecting the touch pressure, or by differentiating a time interval for detecting the touch position from a time interval for detecting the touch pressure.

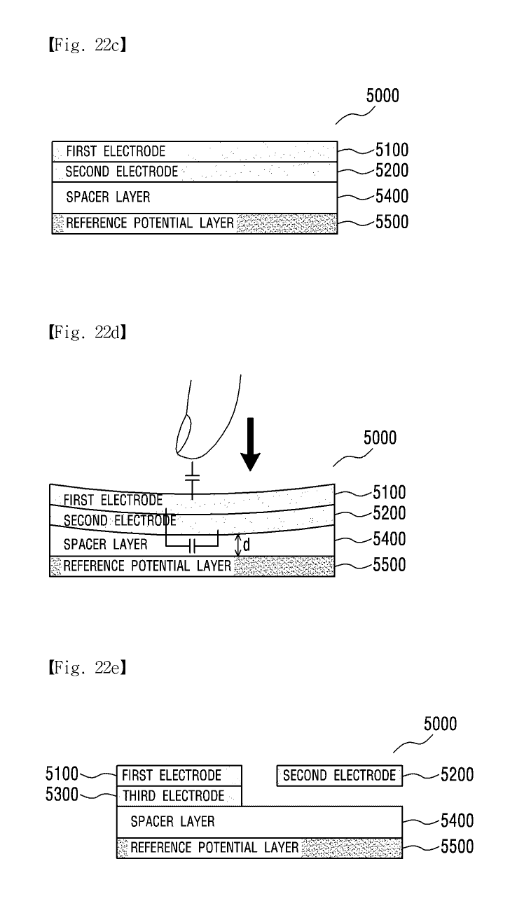

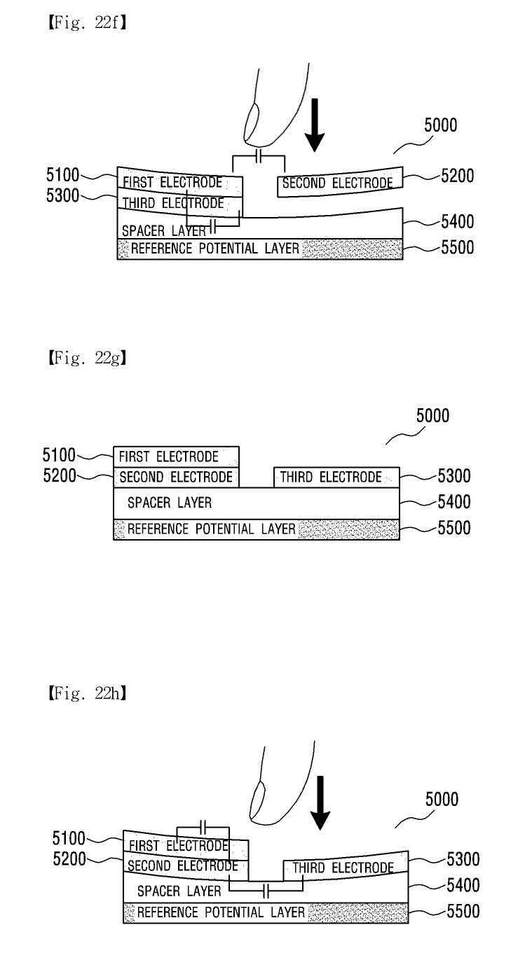

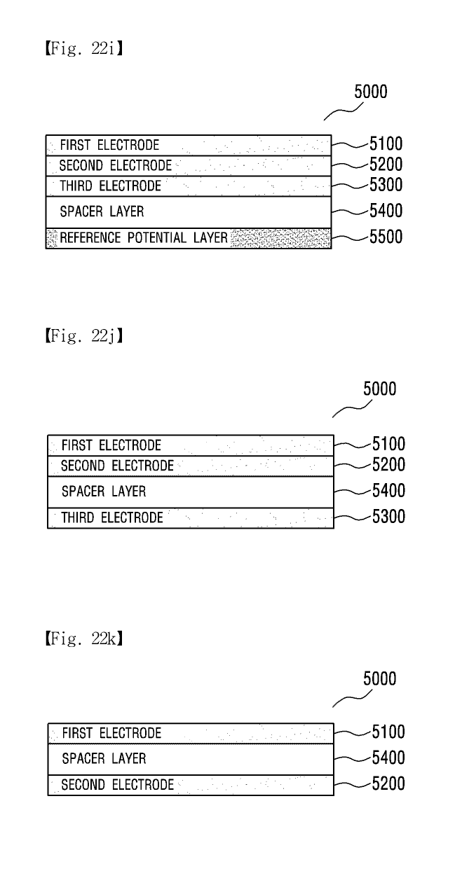

FIGS. 22a to 22k are views showing the structure of the touch position-pressure detection module according to the second embodiment. As shown in FIGS. 22a to 22k, the touch position-pressure detection module 5000 according to the second embodiment may include a spacer layer 5400.

As shown in FIGS. 22a to 22i, the touch position-pressure detection module 5000 according to the embodiment may include a reference potential layer 5500. The reference potential layer 5500 is the same as that of the foregoing referring to FIGS. 20a to 20d, and thus, a description of the reference potential layer 5500 will be omitted. The reference potential layer may include a layer which is parallel with a two-dimensional plane in which a below-described first electrode 5100 for detecting the touch pressure has been formed, a two-dimensional plane in which a below-described second electrode 5200 for detecting the touch pressure has been formed, or a two-dimensional plane in which a below-described third electrode 5300 for detecting the touch pressure has been formed.

As shown in FIG. 22a, the touch position-pressure detection module 5000 according to the embodiment may include the first electrode 5100 formed in one layer, the spacer layer 5400 formed under the layer in which the first electrode 5100 has been formed, and the reference potential layer 5500 formed under the spacer layer 5400.

A description of the configuration of FIGS. 22a and 22b is similar to the description referring to FIGS. 20a and 20b. Hereafter, only the difference between them will be described. As shown in FIG. 22b, when the object like the user's finger approaches the first electrode 5100, the finger functions as a ground and the touch position can be detected by the change of the self-capacitance of the first electrode 5100. Also, when a pressure is applied to the touch screen 130 by the object, a distance “d” between the first electrode 5100 and the reference potential layer 5500 is changed, and thus, the touch pressure can be detected by the change of the self-capacitance of the first electrode 5100.

As shown in FIG. 22c, the touch position-pressure detection module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the reference potential layer 5500 formed under the spacer layer 5400.

A description of the configuration of FIGS. 22c to 22f is similar to the description referring to FIGS. 20c and 20d. Hereafter, only the difference between them will be described. Here, the first electrode 5100 and the second electrode 5200 may be, as shown in FIG. 26a, comprised of the plurality of electrodes 6100 respectively. As shown in FIG. 22d, when the object like the user's finger approaches the first electrode 5100, the finger functions as a ground and the touch position can be detected by the change of the self-capacitance of the first electrode 5100. Also, when a pressure is applied to the touch screen 130 by the object, a distance “d” between the reference potential layer 5500 and both the first electrode 5100 and the second electrode 5200 is changed, and thus, the touch pressure can be detected by the change of the mutual capacitance between the first electrode 5100 and the second electrode 5200.

Also, according to the embodiment, each of the first and second electrodes 5100 and 5200 may be, as shown in FIG. 26b, comprised of the plurality of first electrodes 6200 and the plurality of second electrodes 6300. The plurality of first electrodes 6200 and the plurality of second electrodes 6300 may be arranged to cross each other. Here, the touch position can be detected by the change of the mutual capacitance between the first electrode 5100 and the second electrode 5200, and the touch pressure can be detected by the change of the self-capacitance of the second electrode 5200 according to the change of a distance “d” between the second electrode 5200 and the reference potential layer 5500. Also, according to the embodiment, the touch position can be detected by the change of the mutual capacitance between the first electrode 5100 and the second electrode 5200, and also, the touch pressure can be detected by the change of the mutual capacitance between the first electrode 5100 and the second electrode 5200 according to the change of the distance “d” between the reference potential layer 5500 and both the first electrode 5100 and the second electrode 5200.

Here, even when the first electrode 5100 and the second electrode 5200 are formed in the same layer, the touch position and touch pressure can be also detected as described with reference to FIGS. 22c and 22d. However, in FIGS. 22c and 22d, regarding the embodiment where the electrode should be configured as shown in FIG. 26b, when the first electrode 5100 and the second electrode 5200 are formed in the same layer, the first electrode 5100 and the second electrode 5200 may be configured as shown in FIG. 26c.

As shown in FIG. 22e, the touch position-pressure detection module 5000 according to the embodiment may include the first electrode 5100 and the second electrode 5200 which have been in the same layer, the third electrode 5300 which has been formed in a layer under the layer in which the first electrode 5100 and the second electrode 5200 have been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 26c, and the first electrode 5100 and the third electrode 5300 may be configured and arranged as shown in FIG. 26b. As shown in FIG. 22f, when the object like the user's finger approaches the first electrode 5100 and the second electrode 5200, the mutual capacitance between the first electrode 5100 and the second electrode 5200 is changed, so that the touch position can be detected. When a pressure is applied to the touch screen 130 by the object, a distance “d” between the reference potential layer 5500 and both the first electrode 5100 and the third electrode 5300 is changed, and then the mutual capacitance between the first electrode 5100 and the third electrode 5300 is hereby changed, so that the touch pressure can be detected. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 22g, the touch position-pressure detection module 5000 according to the embodiment may include the first electrode 5100 formed in one layer, the second electrode 5200 formed in a layer under the layer in which the first electrode 5100 has been formed, the third electrode 5300 formed in the same layer as the layer in which the second electrode 5200 has been formed, the spacer layer 5400 formed under the layer in which the second electrode 5200 and the third electrode 5300 have been formed, and the reference potential layer 5500 formed under the spacer layer 5400.

Here, the first electrode 5100 and the second electrode 5200 may be configured and arranged as shown in FIG. 26b, and the second electrode 5200 and the third electrode 5300 may be configured and arranged as shown in FIG. 26c. In FIG. 22h, the touch position can be detected by the change of the mutual capacitance between the first electrode 5100 and the second electrode 5200, and the touch pressure can be detected by the change of the mutual capacitance between the second electrode 5200 and the third electrode 5300. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 22i, the touch position-pressure detection module 5000 according to the embodiment may include the first electrode 5100 formed in one layer, the second electrode 5200 formed in a layer under the layer in which the first electrode 5100 has been formed, the third electrode 5300 formed under the layer in which the second electrode 5200 has been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 26b, and the second electrode 5200 and the third electrode 5300 may be also configured and arranged as shown in FIG. 26b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch screen 130 by the object, a distance “d” between the reference potential layer 5500 and both the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 22j, the touch position-pressure detection module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the third electrode 5300 formed under the spacer layer 5400.

Here, the first electrode 5100 and the second electrode 5200 may be configured and arranged as shown in FIG. 26b, and the third electrode 5300 may be configured as shown in FIG. 26a or the second electrode 5200 and the third electrode 5300 may be also configured and arranged as shown in FIG. 26b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch screen 130 by the object, a distance “d” between the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 22k, the touch position-pressure detection module 5000 according to the embodiment may include the first electrode 5100 formed in one layer, the spacer layer 5400 formed under the layer in which the first electrode 5100 has been formed, and the second electrode 5200 formed under the spacer layer 5400.

Here, the first electrode 5100 and the second electrode 5200 may be configured and arranged as shown in FIG. 26b. Here, the touch position can be detected by the change of the mutual capacitance between the first electrode 5100 and the second electrode 5200. Also, when a pressure is applied to the touch screen 130 by the object, a distance “d” between the first electrode 5100 and the second electrode 5200 is changed, so that the touch pressure can be detected by the change of the mutual capacitance between the first electrode 5100 and the second electrode 5200. The first electrode 5100 and the second electrode 5200 may be configured and arranged as shown in FIG. 26a. Here, when the object like the user's finger approaches the first electrode 5100, the finger functions as a ground and the self-capacitance of the first electrode 5100 is changed, so that the touch position can be detected. Also, the touch pressure can be detected by the change of the mutual capacitance between the first electrode 5100 and the second electrode 5200.

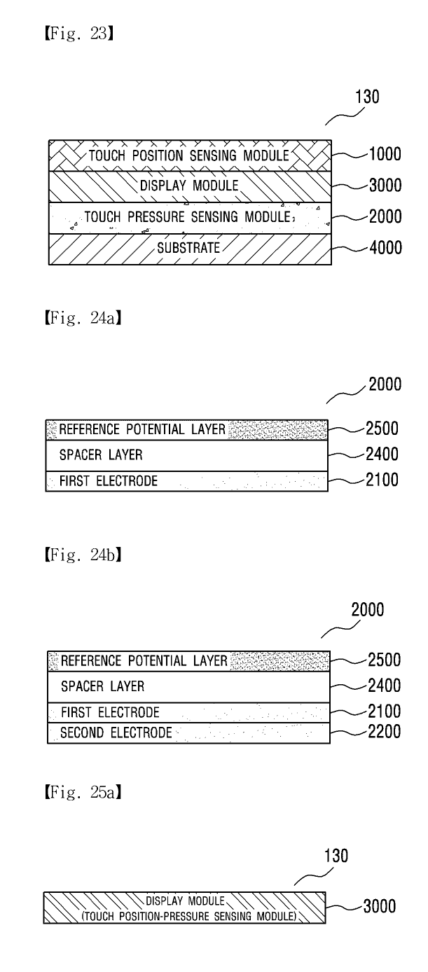

As shown in FIG. 23, the touch screen 130 according to a third embodiment may include the touch position detection module 1000, the display module 3000 disposed under the touch position detection module 1000, the touch pressure detection module 2000 disposed under the display module 3000, and the substrate 4000 disposed under the touch pressure detection module 2000.

In the touch screens 130 according to the embodiment shown in FIGS. 18 and 21, since the touch pressure detection module 2000 which includes the spacer layer 2400 or the touch position-pressure detection module 5000 which includes the spacer layer 5400 is disposed on the display module 3000, the color clarity, visibility, optical transmittance of the display module 3000 may be reduced. Therefore, in order to prevent such problems, the touch position detection module 1000 and the display module 3000 are fully laminated by using an adhesive like an optically clear adhesive (OCA), and the touch pressure detection module 2000 is disposed under the display module 3000. As a result, the aforementioned problem can be alleviated and solved. Also, an existing gap formed between the display module 3000 and the substrate 4000 is used as the spacer layer for detecting the touch pressure, so that the overall thickness of the touch screen 130 can be reduced.

The touch position detection module 1000 according to the embodiment shown in FIG. 23 is the same as the touch position detection module shown in FIGS. 19a to 19d.

The touch pressure detection module 2000 according to the embodiment shown in FIG. 23 may be the touch pressure detection module shown in FIGS. 20a to 20f and the touch pressure detection module shown in FIGS. 24a to 24b.

As shown in FIG. 24a, the touch pressure detection module 2000 according to the embodiment may include the reference potential layer 2500, the spacer layer 2400 formed under the reference potential layer 2500, and the first electrode 2100 formed under the spacer layer 2400. Since the configuration and operation of FIG. 24a are the same as those of FIGS. 20a and 20b with the exception of the fact that the relative position of the reference potential layer 2500 and the relative position of the first electrode 2100 are replaced with each other, repetitive descriptions thereof will be omitted hereafter.

As shown in FIG. 24b, the touch pressure detection module 2000 according to the embodiment may include the reference potential layer 2500, the spacer layer 2400 formed under the ground, the first electrode 2100 formed in a layer under the spacer layer 2400, and the second electrode 2200 formed in a layer under the layer in which the first electrode 2100 has been formed. Since the configuration and operation of FIG. 24b are the same as those of FIGS. 20c and 20d with the exception of the fact that the relative position of the reference potential layer 2500, the position of the first electrode 2100 and the relative position of the second electrode 2200 are replaced with each other, repetitive descriptions thereof will be omitted hereafter. Here, even when the first electrode 2100 and the second electrode 2200 are formed in the same layer, the touch pressure can be detected as described in FIGS. 20c and 20d.

Although it has been described in FIG. 23 that the display module 3000 is disposed under the touch position detection module 1000, the touch position detection module 1000 can be included within the display module 3000. Also, although it has been described in FIG. 23 that the touch pressure detection module 2000 is disposed under the display module 3000, a portion of the touch pressure detection module 2000 can be included within the display module 3000. Specifically, the reference potential layer 2500 of the touch pressure detection module 2000 may be disposed within the display module 3000, and the electrodes 2100 and 2200 may be formed under the display module 3000. As such, when the reference potential layer 2500 is disposed within the display module 3000, a gap formed within the display module 3000 is used as the spacer layer for detecting the touch pressure, so that the overall thickness of the touch screen 130 can be reduced. Here, the electrodes 2100 and 2200 may be formed on the substrate 4000. As such, when the electrodes 2100 and 2200 are formed on the substrate 4000, not only the gap formed within the display module 3000 but also the gap formed between the display module 3000 and the substrate 4000 is used as the spacer layer for detecting the touch pressure, so that the sensitivity for detecting the touch pressure can be more improved.

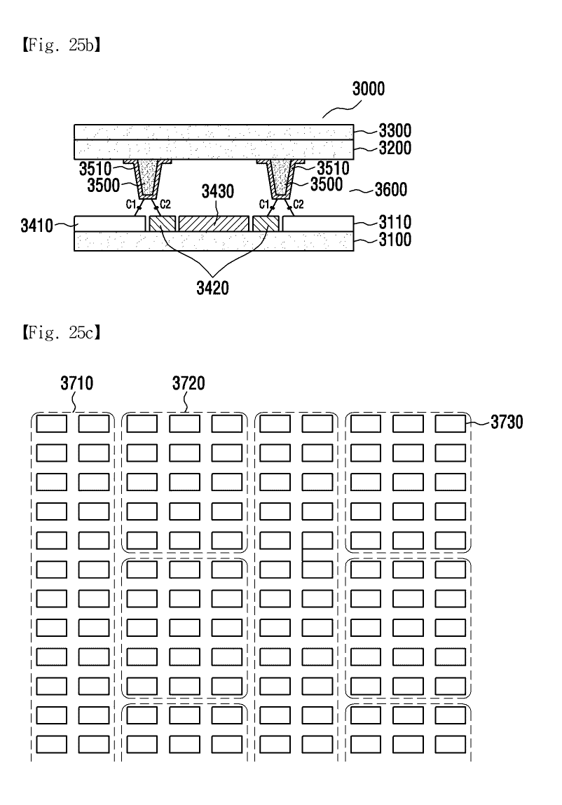

FIG. 25a shows a structure of the touch screen according to a fourth embodiment. As shown in FIG. 25a, the touch screen 130 according to the fourth embodiment may include at least one of the touch position detection module and the touch pressure detection module within the display module 3000.

FIGS. 25b and 25c are structure views of touch pressure detection and touch position detection of the touch screen according to the fourth embodiment. FIGS. 25b and 25c take an LCD panel as an example of the display module 3000.

In case of the LCD panel, the display module 3000 may include a TFT layer 3100 and a color filter layer 3300. The TFT layer 3100 includes a TFT substrate layer 3110 disposed directly thereon. The color filter layer 3300 includes a color filter substrate layer 3200 disposed directly thereunder. The display module 3000 includes a liquid crystal layer 3600 between the TFT layer 3100 and the color filter layer 3300. Here, the TFT substrate layer 3110 includes electrical components necessary to generate an electric field driving the liquid crystal layer 3600. Particularly, the TFT substrate layer 3110 may be comprised of various layers including a data line, a gate line, TFT, a common electrode, a pixel electrode and the like. These electrical components generate a controlled electric field and orient the liquid crystals in the liquid crystal layer 3600. More specifically, The TFT substrate layer 3110 may include a column common electrode (column Vcom) 3430, a low common electrode (low Vcom) 3410, and a guard shield electrode 3420. The guard shield electrode 3420 is located between the column common electrode 3430 and the low common electrode 3410 and is able to minimize the interference caused by a fringe field which may be generated between the column common electrode 3430 and the low common electrode 3410. The foregoing description of the LCD panel is apparent to those skilled in the art.

As shown in FIG. 25b, the display module 3000 according to the embodiment of the present invention may include sub-photo spacers 3500 disposed on the color filter substrate layer 3200. These sub-photo spacers 3500 may be disposed on the interface between the low common electrode 3410 and the adjacent guard shield electrode 3420. Here, a conductive material layer 3510 such as ITO may be patterned on the sub-photo spacer 3500. Here, a fringing capacitance C1 is formed between the low common electrode 3410 and the conductive material layer 3510, and a fringing capacitance C2 is formed between the guard shield electrode 3420 and the conductive material layer 3510.

When the display module 3000 shown in FIG. 25b functions as the touch pressure detection module, a distance between the sub-photo spacers 3500 and the TFT substrate layer 3110 may be reduced by an external pressure, and thus, a capacitance between the low common electrode 3410 and the guard shield electrode 3420 may be reduced. Accordingly, in FIG. 25b, the conductive material layer 3510 functions as the reference potential layer and detects the change of the capacitance between the low common electrode 3410 and the guard shield electrode 3420, so that the touch pressure can be detected.

FIG. 25c shows a structure in which the LCD panel as the display module 3000 is used as the touch position detection module. The arrangement of the common electrodes 3730 is shown in FIG. 25c. Here, for the purpose of detecting the touch position, these common electrodes 3730 may be divided into a first area 3710 and a second area 3720. Accordingly, for example, the common electrodes 3730 included in one first area 3710 may be operated in such a manner as to function in response to the first electrode 6400 of FIG. 26c, and the common electrodes 3730 included in one second area 3720 may be operated in such a manner as to function in response to the second electrode 6500 of FIG. 26c. That is, in order that the common electrodes 3730, i.e., electrical components for driving the LCD panel are used to detect the touch position, the common electrodes 3730 may be grouped. Such a grouping can be accomplished by a structural configuration and manipulation of operation.

As described above, in FIG. 25, the electrical components of the display module 3000 are caused to operate in conformity with their original purpose, so that the display module 3000 performs its own function. Also, at least some of the electrical components of the display module 3000 are caused to operate for detecting the touch pressure, so that the display module 3000 functions as the touch pressure detection module. Also, at least some of the electrical components of the display module 3000 are caused to operate for detecting the touch position, so that the display module 3000 functions as the touch position detection module. Here, each operation mode may be performed in a time-division manner. In other words, the display module 3000 may function as the display module in a first time interval, as the pressure detection module in a second time interval, and/or as the position detection module in a third time interval.

FIGS. 25b and 25c only show the structures for the detection of the touch pressure and the touch position respectively for convenience of description. So long as the display module 3000 can be used to detect the touch pressure and/or the touch position by operating the electrical components for the display operation of the display module 3000, the display module 3000 can be included in the fourth embodiment.

According to FIG. 1, when the touch occurs on the touch screen 130, the processor 140 can calculate whether the touch occurs on the touch screen 130 or not and the position of the touch. Also, the processor 140 can measure the amount of the capacitance change occurring according to the touch when the touch occurs on the touch screen 130.

Specifically, through the touch position detection module 1000 or the touch position-pressure detection module 5000 of the touch screen 130, the processor 140 can measure capacitance change amount according to the approach of an object 10 to the touch screen 130 and can calculate the touch position from the measured capacitance change amount.

Also, the size of the capacitance change amount may be changed according to the touch pressure when the touch occurs. Therefore, when the touch occurs on the touch screen 130, the processor 140 can measure the size of the capacitance change amount according to the touch pressure. Here, the less the touch pressure becomes, the less the capacitance change amount becomes, and the greater the touch pressure becomes, the greater the capacitance change amount becomes.

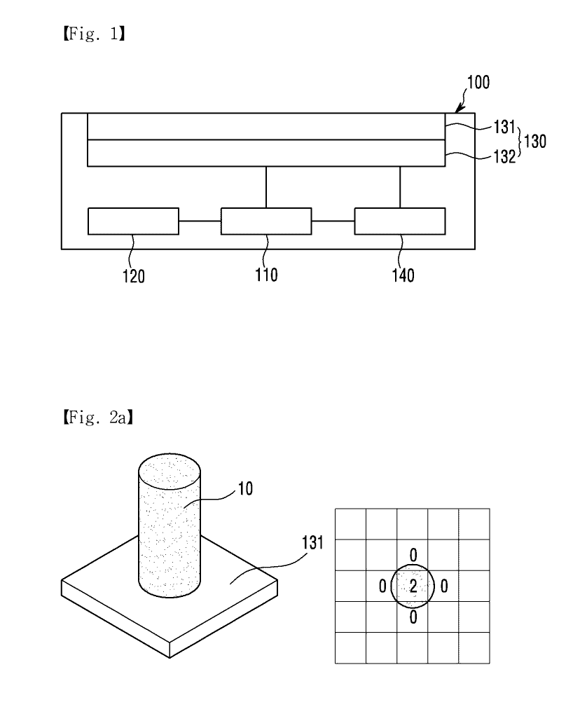

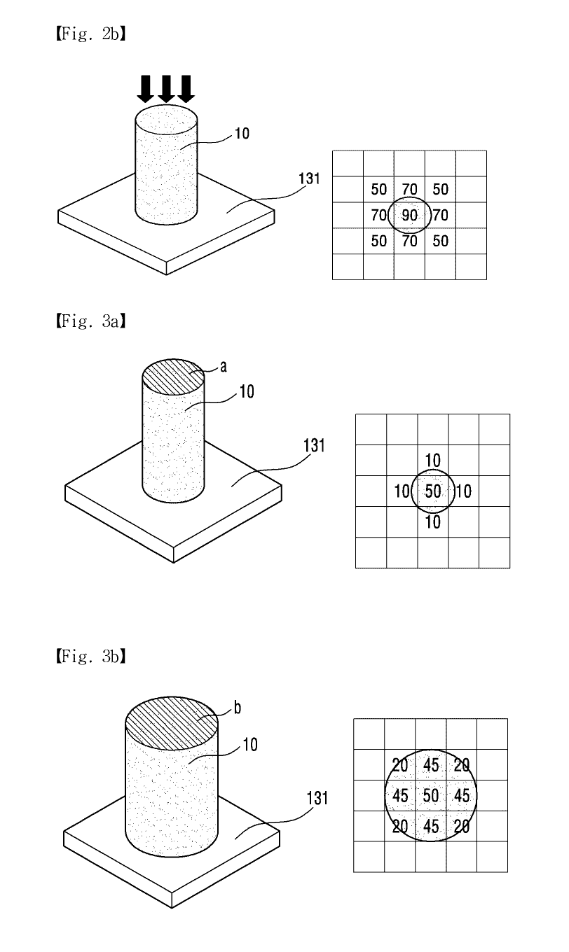

Specifically, the processor 140 may measure the capacitance change amount caused by the pressure which is applied from the object 10 to the touch screen 130 through the touch pressure detection module 2000 or the touch position-pressure detection module 5000 of the touch screen 130 and may calculate the touch pressure from the measured capacitance change amount. The capacitance change amount which is generated by the object 10 touching the touch screen 130 can be measured by summing the capacitance change amounts of each of a plurality of sensing cells. For example, as shown in FIG. 2a, when a common touch is input to the touch screen 130 by the object 10, the sum of the capacitance change amounts is 2. Also, as shown in FIG. 2b, when the touch with pressure is input to the touch screen 130 by the object 10, the sum of the capacitance change amounts is 570 (=90+70+70+70+70+50+50+50+50).

In particular, although the processor 140 according to the embodiment of the present invention does not touch directly the touch screen 130, the processor 140 is able to recognize a hovering state in which the object like the finger is close enough to the touch screen 130 to cause the change of the capacitance in the touch screen 130.

For example, when the object is located within about 2 cm from the surface of the touch screen 130, the processor 140 measures the capacitance change amount according to the approach of the object 10 to the touch screen 130 through the touch position detection module 1000 or the touch position-pressure detection module 5000 of the touch screen 130, and then is able to calculate, from the measured capacitance change amount, whether or not the object exists and the where the object is located.

In order that the movement of the object is recognized as hovering over the touch screen 130, it is desirable that the error of the capacitance change amount which is generated in the touch screen 130 by the hovering is larger than that of the capacitance change which is generated in the common touch screen 130.

The size of the capacitance change amount in the touch screen 130, which is generated during the hovering of the object, may be smaller than that of the capacitance change amount of the direct touch on the touch screen 130. Hereafter, the touch on the touch screen 130 may include the hovering. For example, the hovering may be classified as having the smallest touch pressure.

Therefore, the processor 140 may detect the capacitance change amount generated in the touch screen 130, may calculate whether the touch occurs or not, the touch position and touch pressure magnitude, or may measure the capacitance change amount caused by the touch.

Touch information including the measured capacitance change amount and at least any one of the touch position and the touch pressure magnitude calculated from the measured capacitance change amount is transferred to the controller 110 by the processor 140. Here, the controller 110 may calculate a touch time period by using the capacitance change amount transferred from the processor 140.

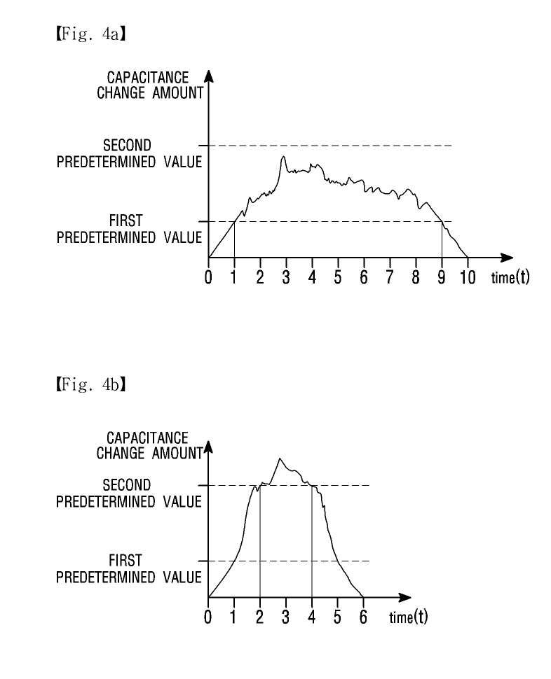

Specifically, when the touch on the touch screen 130 corresponds to the hovering, the controller 110 measures a time period during which the capacitance change amount is maintained from a first predetermined value to a second predetermined value, and thus, calculates a time period during which the object touches the touch screen 130. Here, the first predetermined value may be the minimum value of the capacitance change amount which causes the touch to be recognized as the hovering, and the second predetermined value may be the maximum value of the capacitance change amount which causes the touch to be recognized as the hovering. For example, when the first predetermined value is 5 and the second predetermined value is 15, a time period during which the capacitance change amount is maintained from 5 to 15 is, as shown in FIG. 4a, 8t, so that the touch time period of the hovering is 8t.

Also, when the touch occurs directly on the touch screen 130, the controller 110 measures a time period during which the capacitance change amount is maintained greater than the second predetermined value, and thus, calculates a time period during which the object touches the touch screen 130. For example, when the second predetermined value is 15, a time period during which the capacitance change amount is maintained greater than 15 is, as shown in FIG. 4b, 2t, so that the touch time period of the direct touch is 2t.

Also, the controller 120 may calculate a touch region from the capacitance change amount received from the processor 140. For example, when, as shown in FIG. 3, an area “a” of the object 10 touching on the touch screen 130 is small, the touch region may be the middle one cell area which exceeds the second predetermined value of 15. Also, as shown in FIG. 3b, when an area “b” of the object 10 touching on the touch screen 130 is relatively large, the touch region may be an area composed of nine cells which center the touch position and exceed the second predetermined value of 15.

Based on the touch pressure magnitude received from the processor 140, the controller 110 may change the image which is displayed on a change target region around the touch position and may display the changed image on the touch screen 130.

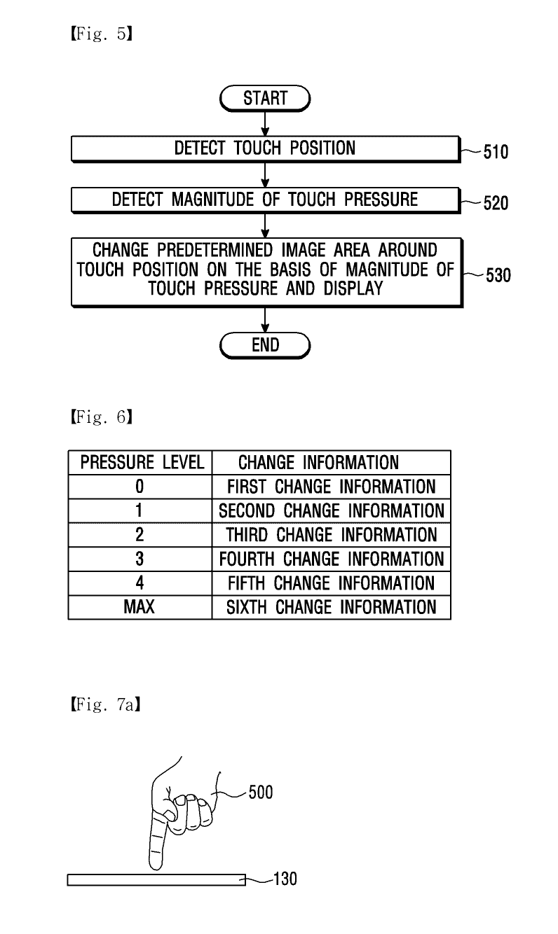

FIG. 5 is a flowchart for describing an image change according to the embodiment of the present invention.

Referring to FIG. 5, the display method according to the embodiment of the present invention includes a step of detecting the touch position (510), a step of detecting the magnitude of the touch pressure (520), and a step of, based on the detected touch pressure magnitude, changing the image which is displayed on the change target region around the touch position and of displaying the changed image on the touch screen 130 (530).

Specifically, when the touch is input, the processor 140 may detect the capacitance change amount depending on the input touch, the touch position, and the magnitude of the touch pressure. The processor 140 transfers the detected touch position and the detected magnitude of the touch pressure to the controller 110. Based on the received magnitude of the touch pressure, the controller 110 may calculate the degree of change of the image which is displayed on the change target region. The controller 110 may change the image, which is displayed on the change target region around the touch position, by using a predetermined changing method in accordance with the calculated degree of change, and may display the changed image on the touch screen 130. Here, the change target region may be within a predetermined distance from the touch position. For example, when the predetermined changing method is to distort, the controller 110 may calculate the degree of distortion of the image which is displayed on the change target region in proportion to the magnitude of the touch pressure. Depending on the calculated degree of distortion, the controller 110 may distort the image which is displayed on the change target region around the touch position and may display the distorted image on the touch screen 130.

Further, the display method according to the embodiment of the present invention may further include a step of calculating the touch region (525).

Specifically, the processor 140 transfers the capacitance change amount according to the input touch to the controller 110. The controller 110 may calculate the touch region from the received capacitance change amount and may set the change target region on the basis of the calculated touch region. Here, the change target region may be within a predetermined distance from the boundary of the touch region.

FIG. 6 shows image change information according to the embodiment of the present invention.

According to the image change information shown in FIG. 6, the magnitude of the touch pressure is divided by certain ranges. A level (0 to 4, Max) is assigned to each of the ranges. Then, the changing method may be set differently according to the respective levels. For example, when it is assumed that the magnitude of the touch pressure has a value of from 0 to 600, the level may be calculated as a zero level for the magnitude of the touch pressure in a minimum range from greater than 0 to 100, as a first level for the magnitude of the touch pressure in the next larger range from greater than 100 to 200, as a second level for the magnitude of the touch pressure in the next larger range from greater than 200 to 300, as a third level for the magnitude of the touch pressure in the next larger range from greater than 300 to 400, as a fourth level for the magnitude of the touch pressure in the next larger range from greater than 400 to 500, and as a maximum level for the magnitude of the touch pressure in the largest range from greater than 500 to 600.

In this case, the change information including the degree of change of the image which is displayed on the change target region in accordance with the increase of the touch pressure level may be set according to the predetermined changing method. For example, the zero level may be set to correspond to first change information, the first level may be set to correspond to second change information, the second level may be set to correspond to third change information, the third level may be set to correspond to fourth change information, the fourth level may be set to correspond to fifth change information, and the maximum level may be set to correspond to sixth change information. When the changing method is to distort, the image change information according to the embodiment of the present invention may be set such that the degree of distortion becomes higher with the increase of the size of the pressure level.

The controller 110 according to the embodiment may be an application processor. The application processor is able to perform the command interpretation, operation, and control, etc., in the terminal.

The terminal 100 according to the embodiment may further include a memory 120.

The memory 120 may store a program for the operation of the controller 110 or may temporarily store data to be input/output. For example, the memory 120 according to the embodiment may store the image change information set for changing the image on the basis of the magnitude of the touch pressure. The memory 120 may include at least one type of a storage medium selected from the group consisting of a flash memory type, a hard disk type, a multimedia card micro type, card type memory (e.g., SD or XD memory, etc.), random access memory (RAM), static random access memory (SRAM), read-only memory (ROM), electrically erasable programmable read-only memory (EEPROM), a programmable read-only memory (PROM), a magnetic memory, a magnetic disk, and an optical disk.

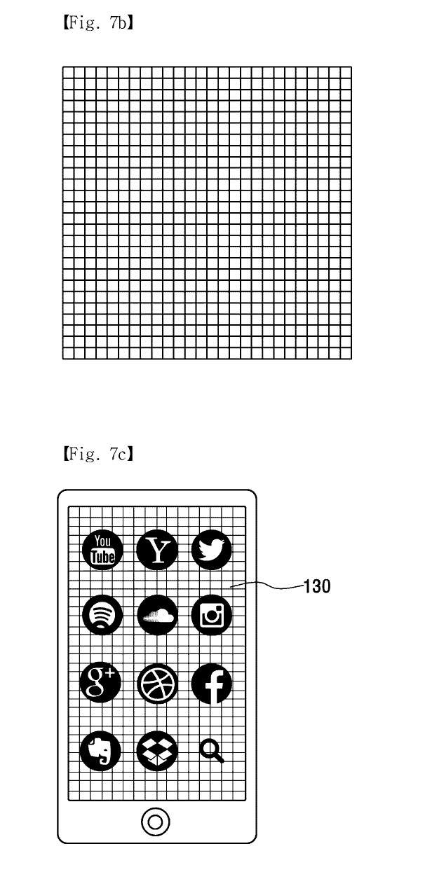

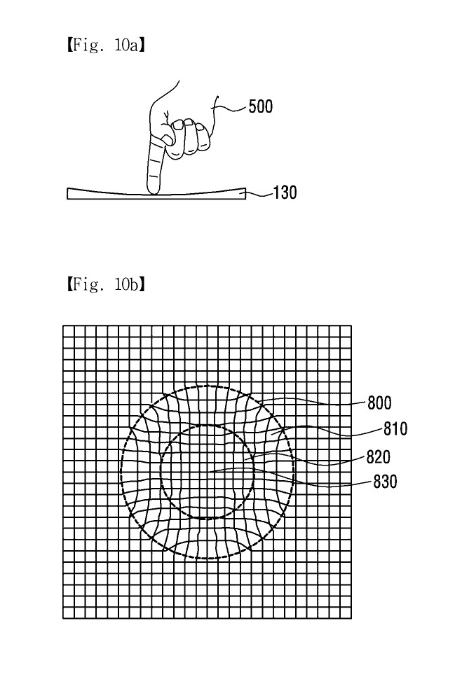

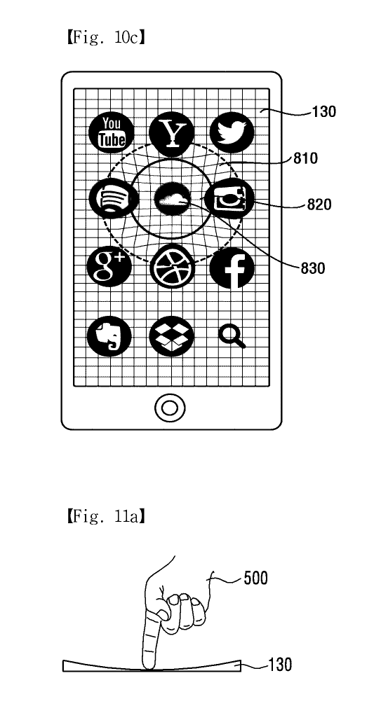

FIGS. 7 to 17 show a method for changing the image in accordance with the magnitude of the touch pressure and for displaying the changed image on the touch screen in accordance with the embodiment of the present invention.

A case where the degree of distortion becomes higher with the increase of the magnitude of the touch pressure in accordance with the first embodiment will be described with reference to FIGS. 7 to 11.

As shown in FIGS. 7 to 11, the image which is displayed on the change target region 800 may be changed and displayed on the touch screen 130 such that the degree of distortion becomes sequentially higher as shown in FIGS. 7c, 8c, 9c, 10c, and 11c with the increase of the magnitude of the touch pressure.

When the touch occurs, as shown in FIG. 7a, on the touch screen 130 by an object 500, the processor 140 may calculate the touch position and the magnitude of the touch pressure by detecting the capacitance change amount generated in the touch screen 130.

The processor 140 transfers the calculated touch position and the calculated magnitude of the touch pressure to the controller 110.

Based on the magnitude of the touch pressure, the controller 110 may detect, as shown in FIG. 6, the touch pressure level and the changing method corresponding to the touch pressure level. Here, when the changing method is to distort, the image change information may include a distortion pattern according to the touch pressure level. When the magnitude of the touch pressure corresponds to the lowest pressure level, the controller 110 may change the image area by using the distortion pattern having the lowest degree of distortion. When the magnitude of the touch pressure corresponds to the highest pressure level, the controller 110 may change the image area by using the distortion pattern having the highest degree of distortion. For example, when the magnitude of the touch pressure corresponds to the zero level, the controller 110 may change the image area by using a first distortion pattern having the lowest degree of distortion. Also, when the magnitude of the touch pressure corresponds to the fourth level, the controller 110 may change the image, which is displayed on the change target region, by using a fifth distortion pattern having the highest degree of distortion.

When the level of the detected touch pressure corresponds to the zero level, the controller 110 applies the first distortion pattern shown in FIG. 7b to the change target region and create the changed image. In this case, the controller 110 applies the first distortion pattern having the lowest degree of distortion, thereby displaying the image with little distortion shown in FIG. 7c on the touch screen 130, because the first distortion pattern has the lowest degree of distortion. Here, as shown in FIGS. 7b and 7c, the first distortion pattern may be a pattern without distortion.

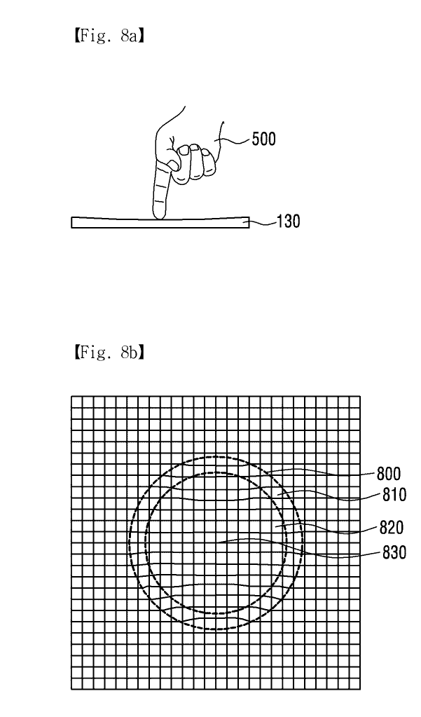

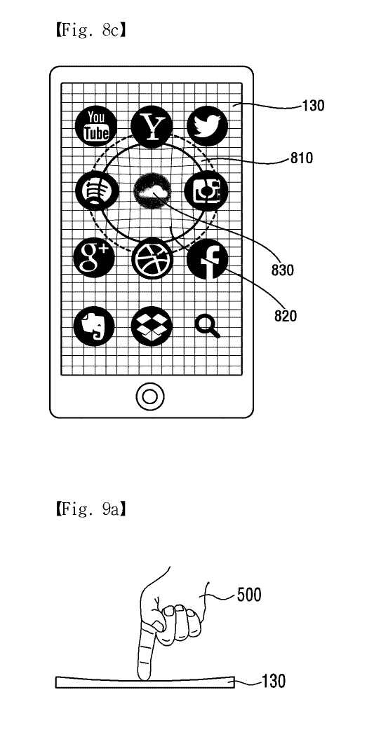

When, as shown in FIG. 8a, the magnitude of the touch pressure corresponds to the first level, the controller 110 may create the changed image shown in FIG. 8b by applying a second distortion pattern to the change target region 800.

In this case, the controller 110 applies, as shown in FIG. 8b, the second distortion pattern to the change target region 800, i.e., a region within a predetermined distance from a touch position 830 according to the touch input, thereby displaying the image distorted more than the image to which the first distortion pattern has been applied on the touch screen 130, because the second distortion pattern has a higher degree of distortion than that of the first distortion pattern.

Specifically, as shown in FIGS. 8b and 8c, the change target region 800 may include a first region 810 and a second region 820 disposed within the first region 810. Here, the image enlarged perpendicularly to the boundary of the first region 810 may be displayed on the first region 810, and the image reduced perpendicularly to the boundary of the second region 820 may be displayed on the second region 820. Also, the image which is displayed on the first region 810 may be enlarged toward the touch position 830. Likewise, the image which is displayed on the second region 820 may be reduced toward the touch position 830. As such, when the image enlarged perpendicularly to the boundary of the first region 810 is displayed on the first region 810 and the image reduced perpendicularly to the boundary of the second region 820 is displayed on the second region 820, an image distorted by being depressed may be displayed.

As shown in FIGS. 9 to 11, when the magnitude of the touch pressure input to the touch screen 130 by the object 500 is increased, the size of the second region 820 may be reduced and when the magnitude of the touch pressure is reduced, the size of the second region 820 may be increased. As such, when the size of the second region 820 is changed according to the magnitude of the touch pressure, the image distorted by being more depressed with the increase of the magnitude of the touch pressure may be displayed.

A case where the degree of distortion becomes higher with the increase of the magnitude of the touch pressure in accordance with the second embodiment will be described with reference to FIGS. 12 to 14.

As shown in FIGS. 12 to 14, the image which is displayed on the change target region 800 may be changed such that the degree of distortion becomes sequentially higher as shown in FIGS. 12b, 13b, and 14b with the increase of the magnitude of the touch pressure.

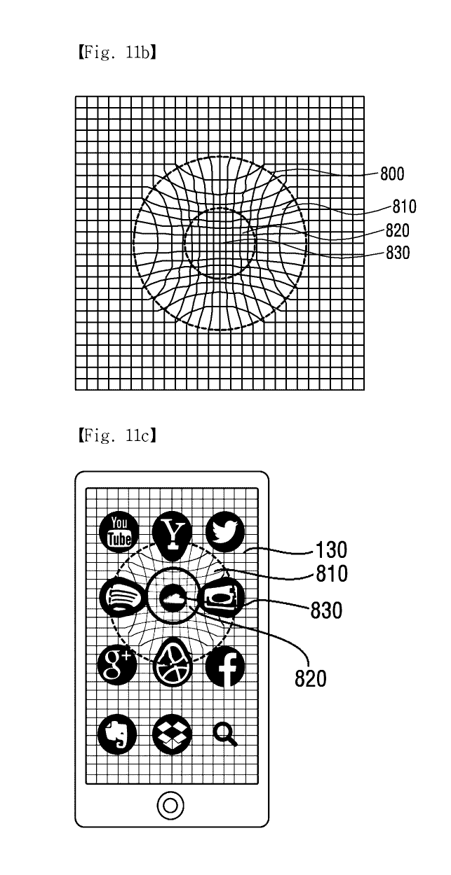

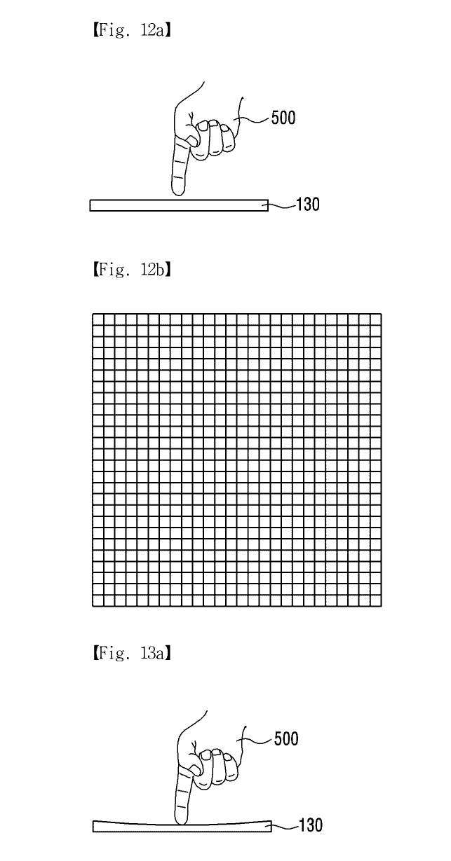

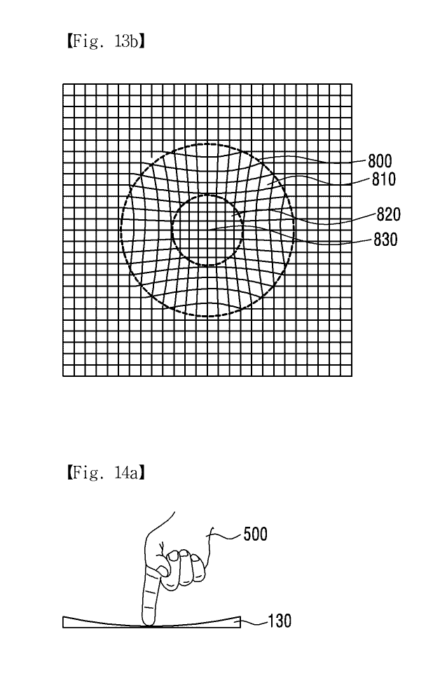

As shown in FIGS. 13 to 14, when the magnitude of the touch pressure input to the touch screen 130 by the object 500 is reduced, the degree of enlargement of the image which is displayed on the first region 810 and the degree of reduction of the image which is displayed on the second region 820 may be reduced. Also, when the magnitude of the touch pressure is increased, the degree of enlargement of the image which is displayed on the first region 810 and the degree of reduction of the image which is displayed on the second region 820 may be increased. As such, by changing the degree of enlargement or reduction of the image which is displayed on the first region 810 and on the second region 820 in accordance with the magnitude of the touch pressure, the image distorted by being more depressed with the increase of the magnitude of the touch pressure may be displayed.

Also, when the magnitude of the touch pressure input to the touch screen 130 is reduced, the size of the second region 820 may be increased and the degree of enlargement of the image which is displayed on the first region 810 and the degree of reduction of the image which is displayed on the second region 820 may be reduced. Also, when the magnitude of the touch pressure is increased, the size of the second region 820 may be reduced and the degree of enlargement of the image which is displayed on the first region 810 and the degree of reduction of the image which is displayed on the second region 820 may be increased. As such, by changing the size of the second region 820 as well as the degree of enlargement or reduction of the image which is displayed on the first region 810 and on the second region 820 in accordance with the magnitude of the touch pressure, the image distorted by being more depressed with the increase of the magnitude of the touch pressure may be displayed.

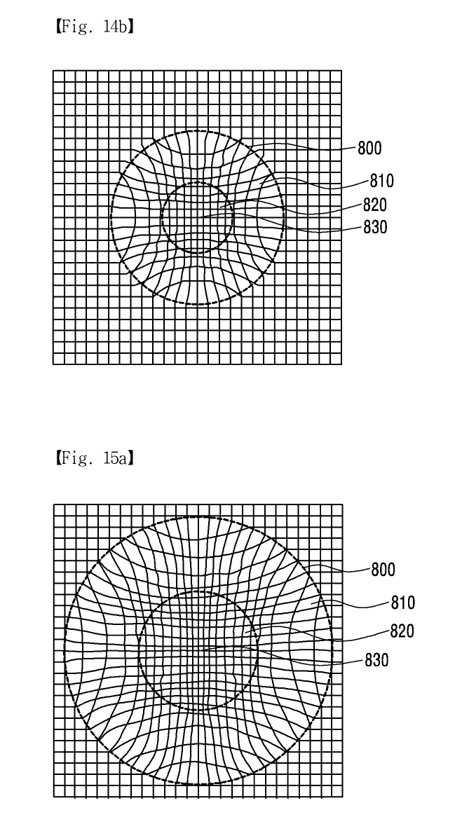

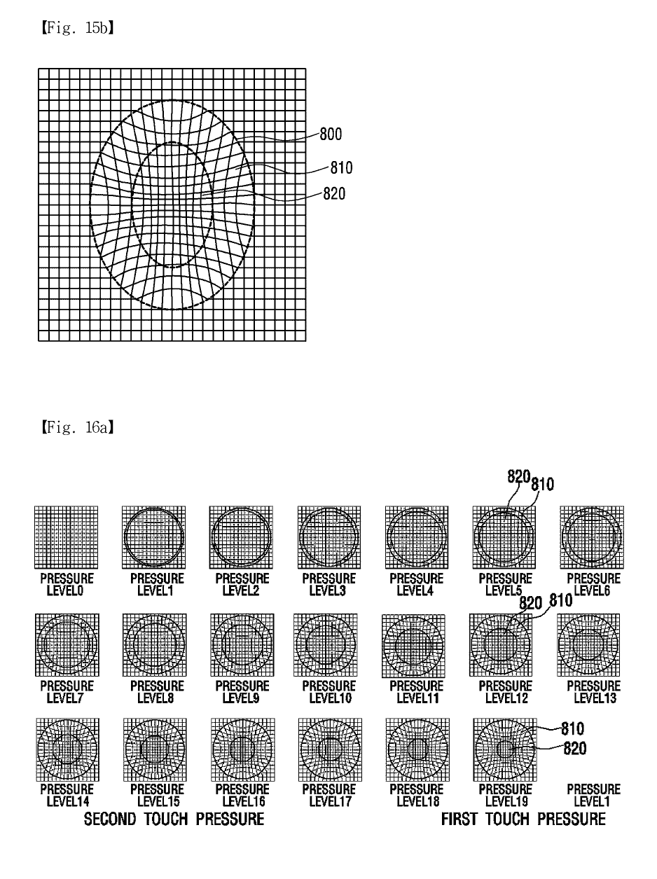

FIG. 15 is a view for describing a method for setting the change target region or the second region in accordance with the touch region.

A case where the change target region or the second region is set according to the touch region will be described with reference to FIGS. 7 to 15.

As shown in FIGS. 7 to 15, when the touch occurs on the touch screen 130, a portion of the changed image which is displayed on the change target region 800 is hidden by the object 500. Accordingly, the change target region 800 may be larger than the touch region input by the object 500 in order that the user is able to easily recognize the image which is displayed on the change target region 800.

Specifically, when the touch occurs on the touch screen 130 by the object 500, the processor 140 may detect the capacitance change amount generated from the touch screen 130 and may transfer to the controller 110.

The controller 110 may calculate the touch region from the received capacitance change amount and may set the change target region 800 on the basis of the calculated touch region. As shown in FIG. 15a, when the size of the touch region is increased, the size of the change target region 800 may be increased. As shown in FIGS. 7 to 14, when the size of the touch region is reduced, the size of the change target region 800 may be reduced. As such, when the size of the change target region 800 is changed according to the size of the touch region, the user is able to easily recognize the image which is displayed on the change target region 800.

Also, the shape of the change target region 800 and the shape of the touch region may have a similar relationship with each other. Even though the size of the circular change target region 800, i.e., the size of the region within a predetermined distance from the touch position is changed according to the size of the touch region, when the object 500 which touches the touch screen 130 does not have a circular shape, the shape of the change target region 800 and the shape of the touch region may be set to have a similar relationship with each other because the image which is displayed on the change target region 800 is still hidden by the object. Specifically, when, as shown in FIG. 15b, the touch region has an elliptical shape like a thumb, the shape of the change target region 800 may be set according to the shape of the touch region. As such, by changing the change target region 800 in accordance with the shape of the touch region, the user is able to easily recognize the image which is displayed on the change target region 800. In more detail, the change target region 800 may be set to be within a predetermined distance from the boundary of the touch region.

Likewise, the shape of the second region 820 and the shape of the touch region may have similar relationship with each other. Also, the touch region may be included in the second region 820. When the touch region is not included in the second region 820, the second region 820 is invisible by being hidden by the object 500, and the user recognizes only the change of the image which is displayed on the first region 810. In this case, the user may not be able to sufficiently recognize that the image displayed on the change target region 800 is changed according to the touch pressure. Therefore, by setting the second region 820 such that the touch region is included in the second region 820, the user is able to always recognize not only the change of the image which is displayed on the first region 810 but also the change of the image which is displayed on the second region 820.

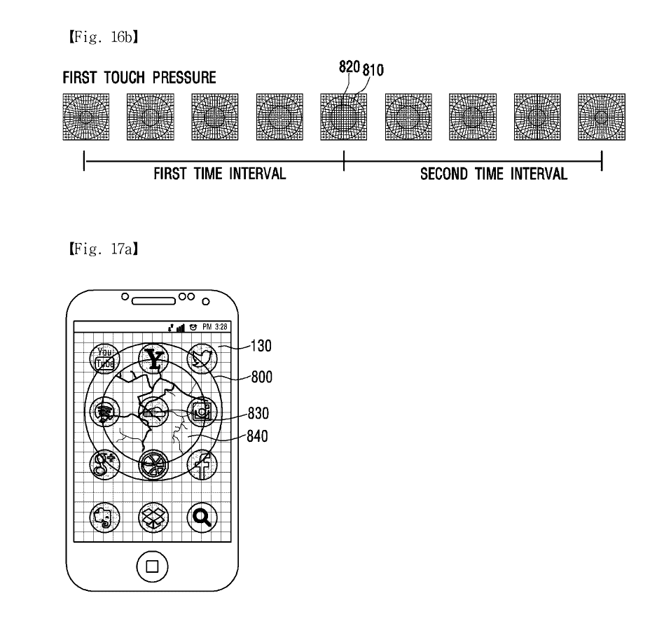

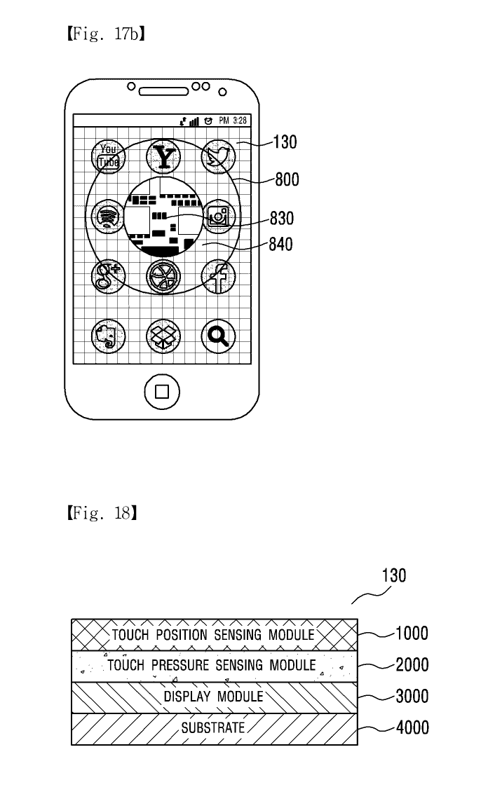

FIGS. 16 and 17 are views for describing a method for informing the user that the magnitude of the pressure of the input touch approaches or reaches a maximum pressure level.

As shown in FIG. 16a, as the magnitude of the touch pressure is increased according to the first embodiment of the present invention, the size of the second region 820 may be reduced. In this case, when the magnitude of the pressure of the input touch exceeds a first predetermined touch pressure value, i.e., the maximum pressure level, the image which is displayed on the change target region 800 may be, as shown in FIG. 16b, changed and displayed on the touch screen 130 for the purpose of informing the user that the magnitude of the pressure of the input touch reaches the maximum pressure level. Specifically, as shown in FIG. 16b, the size of the second region 820 may be increased for a first predetermined time interval, and the size of the second region 820 may be reduced for a second predetermined time interval. Also, the size of the second region 820 may be reduced for the first predetermined time interval, and the size of the second region 820 may be increased for a second predetermined time interval. As such, when the touch with a magnitude greater than the maximum pressure level occurs, the touch screen 130 shows the user the image returns to an image corresponding to the maximum pressure level. As a result, the user is able to recognize that the magnitude of the pressure of the input touch reaches the maximum pressure level.

Likewise, according to the second embodiment, when the magnitude of the pressure of the input touch exceeds the first predetermined touch pressure value, i.e., the maximum pressure level, the degree of enlargement of the image which is displayed on the first region 810 and the degree of reduction of the image which is displayed on the second region 820 may be reduced for the first predetermined time interval, and the degree of enlargement of the image which is displayed on the first region 810 and the degree of reduction of the image which is displayed on the second region 820 may be increased for the second predetermined time interval. Also, the degree of enlargement of the image which is displayed on the first region 810 and the degree of reduction of the image which is displayed on the second region 820 may be increased for the first predetermined time interval, and the degree of enlargement of the image which is displayed on the first region 810 and the degree of reduction of the image which is displayed on the second region 820 may be reduced for the second predetermined time interval.

In order to inform the user that the magnitude of the pressure of the input touch approaches the maximum pressure level, the image which is displayed on the change target region 800 may be, as shown in FIG. 17, changed and displayed on the touch screen 130. Specifically, when the magnitude of the pressure of the input touch exceeds a second predetermined touch pressure value shown in FIG. 16b, the change target region 800 may include, as shown in FIGS. 17a and 17b, a third region 840. Here, a crack image or a circuit board image may be displayed on the third region 840. Specifically, the third region 840 may display a crack image which shows that liquid crystal is broken by the pressure of the input touch or display a circuit board image which shows that the substrate within the terminal is seen by the pressure of the input touch. Here, when the magnitude of the touch pressure is increased, the size of the third region 840, the magnification of the image which is displayed on the third region 840, or the brightness or saturation of the image which is displayed on the third region 840 may be increased. As such, the image which is displayed on the change target region 800 is changed with the increase of the touch pressure, so that the user is able to more easily recognize that the magnitude of the pressure of the input touch approaches the maximum pressure level.

Here, the increase of the magnification of the image which is displayed on the third region 840 includes the increase of the thickness of the crack image which is displayed on the third region 840.

As described above, the terminal 100 according to the embodiment changes the image in accordance with the magnitude of the touch pressure and displays, thereby providing information that allows the user to visually recognize the magnitude of the touch pressure.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although preferred embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A terminal comprising:
a touch screen;
a processor; and
a controller;
wherein, when a touch is input to the touch screen, the processor detects a position of the touch and a magnitude of a pressure of the touch and transfers information on the touch position and information on the magnitude of the touch pressure to the controller;
wherein, based on the magnitude of the touch pressure, the controller changes an image which is displayed on a change target region around the touch position, and displays the changed image on the touch screen; and
wherein the change target region comprises a first region and a second region disposed within the first region, an image enlarged perpendicularly to the boundary of the first region is displayed on the first region, and an image reduced perpendicularly to the boundary of the second region is displayed on the second region.

2. The terminal of claim 1,
wherein the processor transfers a signal including information on a capacitance change amount according to the input touch to the controller;
wherein the controller calculates a touch region based on the capacitance change amount; and
wherein, when a size of the touch region is increased, a size of the change target region is increased, and when the size of the touch region is reduced, the size of the change target region is reduced.

3. The terminal of claim 2, wherein a shape of the change target region and a shape of the touch region have a similar relationship with each other.

4. The terminal of claim 1, wherein, when the magnitude of the touch pressure is reduced, a size of the second region is increased, and when the magnitude of the touch pressure is increased, the size of the second region is reduced.

5. The terminal of claim 4, wherein, when the magnitude of the touch pressure exceeds a first predetermined touch pressure value, the size of the second region is reduced for a first time interval, and the size of the second region is increased for a second time interval.

6. The terminal of claim 5,
wherein the processor transfers a signal including information on a capacitance change amount according to the input touch to the controller;
wherein the controller calculates a touch region based on the capacitance change amount; and
wherein the touch region is included in the second region.

7. The terminal of claim 4, wherein, when the magnitude of the touch pressure exceeds a second predetermined touch pressure value, the change target region comprises a third region which displays a crack image or a circuit board image.

8. The terminal of claim 7, wherein, when the magnitude of the touch pressure is increased, a size of the third region is increased.

9. The terminal of claim 7, wherein, when the magnitude of the touch pressure is increased, a magnification of the image which is displayed on the third region is increased.

10. The terminal of claim 7, wherein, when the magnitude of the touch pressure is increased, a brightness or saturation of the image which is displayed on the third region is increased.

11. The terminal of claim 1, wherein, when the magnitude of the touch pressure is reduced, a degree of enlargement of the image which is displayed on the first region and a degree of reduction of the image which is displayed on the second region are reduced, and when the magnitude of the touch pressure is increased, the degree of enlargement of the image which is displayed on the first region and the degree of reduction of the image which is displayed on the second region are increased.

12. The terminal of claim 11, wherein, when the magnitude of the touch pressure exceeds a first predetermined touch pressure value, the degree of enlargement of the image which is displayed on the first region and the degree of reduction of the image which is displayed on the second region are reduced for a first predetermined time interval, and the degree of enlargement of the image which is displayed on the first region and the degree of reduction of the image which is displayed on the second region are increased for a second predetermined time interval.

13. The terminal of claim 11, wherein, when the magnitude of the touch pressure exceeds a second predetermined touch pressure value, the change target region comprises a third region which displays a crack image or a circuit board image.

14. The terminal of claim 13, wherein, when the magnitude of the touch pressure is increased, a size of the third region is increased.

15. The terminal of claim 13, wherein, when the magnitude of the touch pressure is increased, a magnification of the image which is displayed on the third region is increased.

16. The terminal of claim 13, wherein, when the magnitude of the touch pressure is increased, a brightness or saturation of the image which is displayed on the third region is increased.
